(19) United States
(12) Patent Application Publication
(10) Pub. No.: US 2006/0232528 A1
(43) Pub. Date: Oct. 19, 2006

(54) Apparatus and method for use of large liquid crystal display with small driver

(75) Inventors: Ian Harding, Somerville, MA (US); Sonny Vu, Cambridge, MA (US); Baoguo Wei, Lowell, MA (US); Martin Forest, Cambridge, MA (US); Steven Diamond, Somerville, MA (US); Gary Tsai, Cambridge, MA (US)

Correspondence Address: Marina Larson & Associates, LLC, P.O. BOX 4928, DILLON, CO, 80435, US

(73) Assignee: AGAMATRIX, INC., Cambridge, MA (US)

(21) Appl. No.: 10/907,802

(22) Filed: Apr. 15, 2005

(51) Int. Cl. G09G 3/36

(52) U.S. Cl. 345/87

(57) ABSTRACT

A liquid crystal display driver has N common drive lines and M segment drive lines. A liquid crystal display has M segment driver leads and N times P common drive leads, P being at least two. P multiplexers are provided, each external to the liquid crystal display driver. Each of the M segment driver lines is connected with a respective one of the M segment drive leads. Each multiplexer comprising N switches, each switch defining a normally-open contact, a normally-closed contact, and a common contact. Each of the switches is connected by its common contact with a respective one of the common drive leads of the liquid crystal display. Each of the switches is connected by its normally-closed contact with a cancel signal. The N switches of each multiplexer are each connected with a respective one of the N common drive lines of the liquid crystal display driver.

### BACKGROUND

The invention relates generally to driving of liquid-crystal displays and relates more particularly to techniques for driving them reliably and economically even where the displays have a very large number of display elements.

Some liquid-crystal displays are driven in a simplex fashion, in which each display element has its own corresponding lead, and each lead is connected electrically to a corresponding driver. This has the advantage that the drivers can be very simple, each delivering a particular voltage level depending on whether the associated display element needs to be on or off.

Experience shows, however, that as the number of display elements increases, it becomes less and less realistic to imagine giving each display element its own lead and dedicated driver. A limiting factor is the number of distinct pins that can be squeezed into the portion of the display available for pin connections. For a given shape and size of display, there is some upper bound on the amount of space available for connector pins, and this upper bound can become a limiting factor as described.

As a proposed display grows in size, this upper bound eventually forces the system designer to switch from an LCD technology in which each display element has its own pin and its own driver, to an LCD technology in which each display element is addressed by a “row” and “column” lead. (The addressing also is a function of time and voltage and may also be a function of multiplexing of lines.) In some displays the display elements literally make up a rectangular array in which case the “row” and “column” terminology is literally descriptive of the addressing geometry. In many other displays, however, such as that of FIG. 5, the display elements are not disposed in a Cartesian array but instead are shaped and disposed to form characters, digits, and graphic portrayals. It is then convenient to use terminology of “common” and “segment” leads, each display element being driven by one of the common leads and by one of the segment leads. In a typical arrangement the common leads are in a first plane, and the display elements are in a second plane parallel to the first plane, with the liquid crystal material between the two planes. At least one of the planes is transparent and the human observer views the display through the transparent plane.

For a display with common and segment leads, it is commonplace to use a driver chip (integrated circuit) having drivers made specifically for this purpose. Such a driver chip will have common driver lines and segment driver lines.

FIG. 1 is a prior-art apparatus in which a liquid crystal display 22 has four common drive leads and thirty-two segment drive leads. (These leads together may address as many as 128 display elements.) The apparatus employs an LCD driver 21 having four common drive lines 24 and thirty-two segment drive lines 23. The four common drive lines 24 are connected electrically to four corresponding common drive leads of the liquid crystal display 22. The thirty-two segment drive lines 23 are connected electrically to thirty-two corresponding segment drive leads of the liquid crystal display 22. In this way each of the drive leads of the display 22 is driven by a respective one of the drive lines of the driver 21.

FIG. 2 is a prior-art apparatus in which a liquid crystal display 25 has eight common drive leads and thirty-two segment drive leads. (These leads may address as many as 256 display elements.) The apparatus employs an LCD driver 26 having eight common drive lines 27 and thirty-two segment drive lines 23. The eight common drive lines 27 are connected electrically to eight corresponding common drive leads of the liquid crystal display 25. The thirty-two segment drive lines 23 are connected electrically to thirty-two corresponding segment drive leads of the liquid crystal display 25. In this way each of the drive leads of the display 25 is driven by a respective one of the drive lines of the driver 26.

LCD drivers 26 which have eight common drive lines are much more expensive than LCD drivers 21 which have four common drive lines. It would thus be extremely desirable if an approach could be devised by which an inexpensive LCD driver 21 having only four common drive lines could be employed to drive a display 25 that has eight common drive lines.

### SUMMARY OF THE INVENTION

A liquid crystal display driver has N common drive lines and M segment drive lines. A liquid crystal display has M segment driver leads and N times P common drive leads, P being at least two. P multiplexers are provided, each external to the liquid crystal display driver. Each of the M segment driver lines is connected with a respective one of the M segment drive leads. Each multiplexer comprising N switches, each switch defining a normally-open contact, a normally-closed contact, and a common contact. Each of the switches is connected by its common contact with a respective one of the common drive leads of the liquid crystal display. Each of the switches may further be connected by its normally-closed contact with a cancel signal. The normally-open contacts of the N switches of each multiplexer may also be each connected with a respective one of the N common drive lines of the liquid crystal display driver.

### DESCRIPTION OF THE DRAWING

The invention will be described with respect to a drawing in several figures, of which:

FIG. 1 is a prior-art apparatus with four common drive lines and thirty-two segment drive lines;

FIG. 2 is a prior-art apparatus with eight common drive lines and thirty-two segment drive lines;

FIG. 3 is an apparatus employing a driver having four common drive lines, together with a multiplexer and one selection line, to drive a display having eight common drive lines;

FIG. 4 is an apparatus according to the invention employing a driver having four common drive lines, together with a multiplexer and two selection lines, along with a cancel signal, to drive a display having eight common drive lines;

FIG. 5 is an exemplary liquid crystal display having eight common drive leads and thirty-two segment drive leads;

FIG. 6 shows a single-pole double-throw switch with a common contact 51, a normally closed contact 52, a normally open contact 53, and a control line 50;

FIG. 7 shows a single-pole single-throw switch with a common contact 55, a normally open contact 54, and a control line 56;

FIG. 8 shows a variant of the circuit of FIG. 3;

FIG. 9 shows multiplexing of segment lines rather than common lines;

FIG. 10 shows multiplexing of less than all of the common lines; and

FIGS. 11a-11e .show in more detail the development of a “cancel” signal.

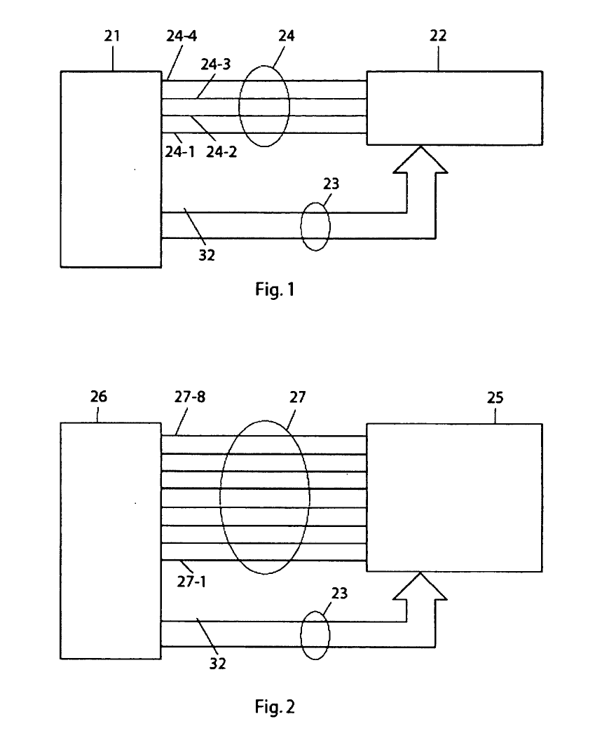

### DETAILED DESCRIPTION

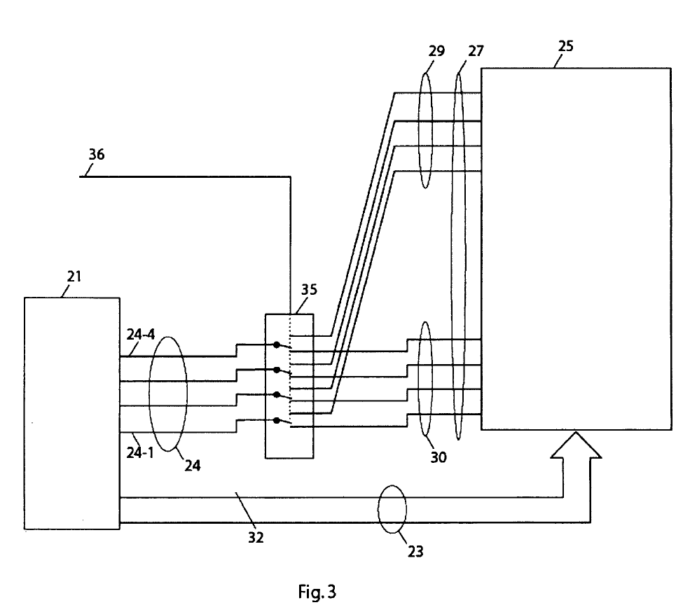

Turning to FIG. 3, what is shown is an apparatus employing a driver 21 having four common drive lines 24, together with a multiplexer 35 and one or more selection lines 36, which allow selection of subsets of the lines. These are used to drive a display 25 having eight common drive lines 27. The driver 21 has thirty-two segment drive lines 23 which connect with respective segment drive leads of the display 25. When selection line 36 is not asserted, then each of the four switches of multiplexer 35 connects to the upper common drive lines 29. When selection line 36 is asserted, then each of the four switches of multiplexer 35 connects to the lower common drive lines 30. While this apparatus does provide an ability to drive a display with eight common lines, experience shows that ghosting sometimes occurs, that is, the non-selected portion of the display may have its display elements partially activated due to leakage (along segment lead conductors) from the selected portion of the display. It will be appreciated that with this arrangement, it is not possible to turn on all of the display elements simultaneously.

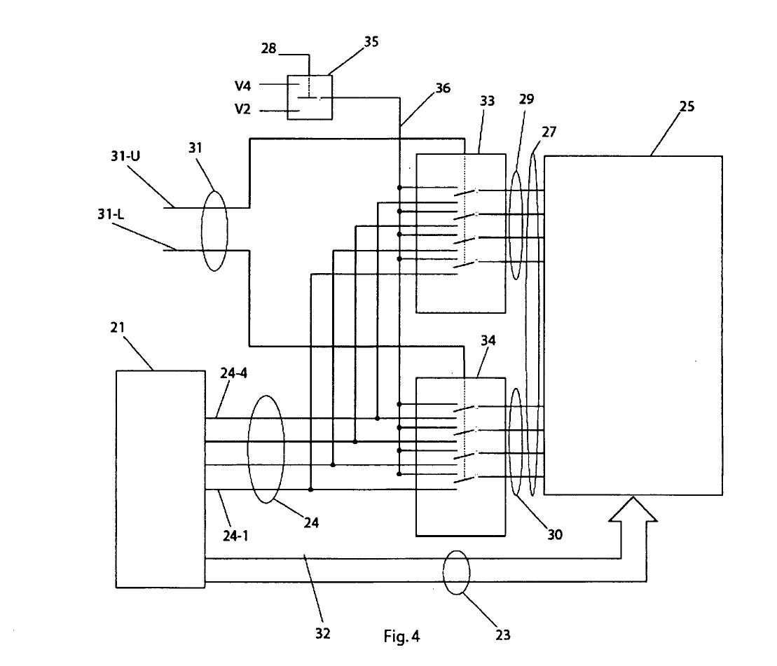

To overcome the ghosting problem, a “cancel” circuit is employed as exemplified by FIG. 4. FIG. 4 is an apparatus according to the invention employing a driver 21 having four common drive lines 24, together with multiplexers 33, 34 and two selection lines 31, along with a cancel signal 36, to drive a display 25 having eight common drive lines 27. The driver 21 has thirty-two segment drive lines 23 which connect with respective segment drive leads of the display 25.

The display 25 is set up with two portions, one called “upper” and the other called “lower”, the two portions laid out so that they need not be active at the same time. For example the measurement progress could be in one portion while the displayed result could be in the other portion. Alternatively, the two portions could be both active at the same time, by asserting lines 31V and 31L at the same time. This is usable, for example, in a power-on self-test when it is desired to activate all of the display elements of the screen. (Note that in this arrangement one cannot be selective—all display elements must be turned on.)

When it is desired to activate the upper portion of the display 25 (the portion addressed by common leads 29), then select line 31-U is asserted and select line 31-L is not asserted. This couples the drive lines 24 to the drive leads 29 through multiplexer 33, and the upper portion of the display 25 is active.

Meanwhile it is desired to control the display elements in the lower portion of the display 25 to reduce or eliminate ghosting. Because select line 31-L is not asserted, multiplexer 34 is in its normally closed position, coupling all of the lower common drive leads 30 with the cancel signal 36. The cancel signal could be a constant voltage, or any of a number of more complex signals or waveforms selected to work with the particular display and other circuit parameters. It turns out, however, to work well if the cancel signal 36 is derived from a switch 35 which switches between two constant voltage levels V2 and V4 as selected by selection line 28. In one embodiment, the selection line 28 is controlled by an otherwise unused (spare) segment control line from the driver chip 21. The cancel signal is preferably phase inverted relative to the drive signals on lines 23.

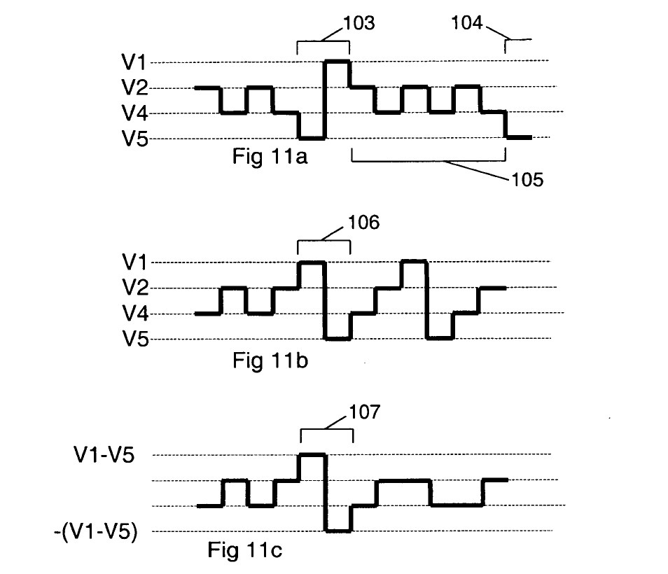

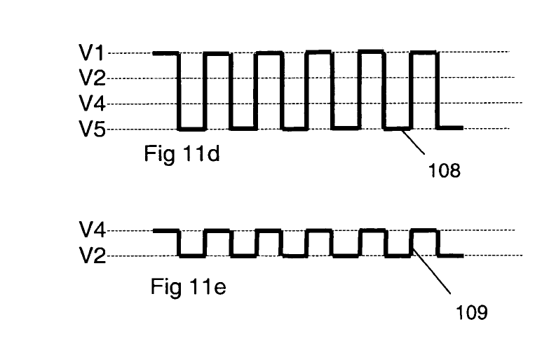

The development of the “cancel” signal will be discussed in some detail in connection with FIGS. 11a-11e.

Turning first to FIG. 11a, what is shown is a typical signal of the type used to drive a “common” drive line which (in this example) is but one of four common drive lines. Each “common” drive line carries an endlessly repeating signal such as is shown in FIG. 11a, each of the four drive lines carrying this signal at a respective phase. The drive line of FIG. 11a is “active” during the interval 103 (and again during interval 104) and is “inactive during the remaining three-quarters of the time, namely during the interval 105. In a typical LCD arrangement, V1 may be 3 volts DC, V2 may be 2 volts, V4 may be 1 volt, and V5 may be zero volts.

Turning now to FIG. 11b, what is seen is a segment drive line. The signal on this line corresponds in the horizontal (time) axis to the signal of FIG. 11a. Suppose a particular display element is to be turned on, namely the display element associated with the common line of FIG. 11a and with the segment line of FIG. 11b. In that case, the segment line will carry the extreme excursion shown in time interval 106. At other times the excursions may be less great.

FIG. 11c shows the net voltage perceived at the particular display element. This voltage is the difference between the voltage of FIGS. 11a and 11b. During the “on” time of interval 107, the display element has a high positive voltage (V1 minus V5) and then has a high negative voltage (the negation of V1 minus V5). The liquid crystal is activated by either of these high voltages (in a typical example, 3 volts or −3 volts) and turns dark (polarizations blocking each other) instead of clear (polarizations aligning).

The rest of the time, when the display element is intended not to be “on”, the net voltage perceived at the display element is smaller, in the typical range of zero to two volts. Such voltages are selected to be insufficient to activate the liquid crystal.

With this background it is instructive to consider what happens at a particular display element if the display element is sometimes at a constant voltage (through the action of one of the multiplexers described above). What happens at the display element is that it receives a net voltage that is the difference between the common drive (e.g. the signal of FIG. 11a) and the constant voltage. The problem is that during some of the time intervals, the net voltage may be sufficient to turn the display element partly on. This is termed “ghosting” and is undesirable.

Experience has shown that if a signal such as that shown in FIG. 11e is used as a “cancel” signal (namely that the multiplexer switches a segment line to the “cancel” signal whenever the segment line is among the segment lines that is not being actively driven), then the “ghosting” is eliminated. The signal shown in FIG. 11e (which swings between V4 and V2 in this example) is out of phase with the common-line drive of (for example) FIG. 11a. As such, this signal tends to counter the extreme excursions of the signal of FIG. 11a (during the active intervals such as interval 103) thus reducing the net voltage seen at a particular display element.

The question then arises how one may generate the signal of FIG. 11e inexpensively. One way to do this is to make use of a spare segment drive line that is being driven as if it were always “on”. Such a drive signal is shown in FIG. 11d. This signal is used to control the switch 35 by means of the above-mentioned selection line 28 (FIG. 4). For example, the selection line 28 may be controlled by an otherwise unused (spare) segment control line from the driver chip 21. The cancel signal is, as described above, preferably phase inverted relative to the drive signals on lines 23.

When it is desired to activate the lower portion of the display 25 (the portion addressed by common leads 30), then select line 31-L is asserted and select line 31-U is not asserted. This couples the drive lines 24 to the drive leads 30 through multiplexer 34, and the lower portion of the display 25 is active.

Meanwhile it is desired to control the display elements in the upper portion of the display 25 to reduce or eliminate ghosting. Because select line 31-U is not asserted, multiplexer 33 is in its normally closed position, coupling all of the upper common drive leads 29 with the cancel signal 36.

Stated differently, the exemplary apparatus comprises a liquid crystal display driver 21 having N common drive lines 24 and M segment drive lines 23, a liquid crystal display 25 having M segment driver leads and N times P common drive leads 27, wherein P is at least two; and P multiplexers 33, 34 external from the liquid crystal display driver; each of the M segment driver lines 23 connected with a respective one of the M segment drive leads; each multiplexer 33, 34 comprising N single-pole double-throw switches, each switch defining a normally-open contact, a normally-closed contact, and a common contact; each of the switches connected by its common contact with a respective one of the common drive leads 24 of the liquid crystal display 25; each of the switches connected by its normally-closed contact with a cancel signal 36; the N switches of each multiplexer each connected with a respective one of the N common drive lines 24 of the liquid crystal display driver 21.

It should be appreciated that the identification of contacts of the switches as normally open or normally closed is arbitrary. If one were inclined to do so, one could reverse the identification of “normally-open” and “normally-closed” and, with suitable changes in the asserted and non-asserted states of the select lines, bring about the same results as are depicted in the discussion above, without departing in any way from the invention.

It will be further appreciated that the control signals may be further split by the use of additional multiplexers.

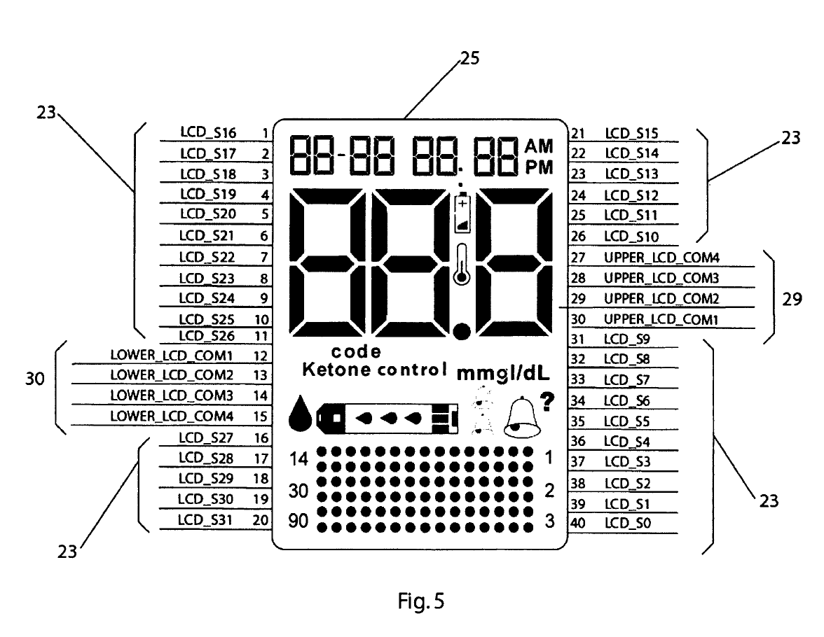

FIG. 5 is an exemplary liquid crystal display having eight common drive leads and thirty-two segment drive leads.

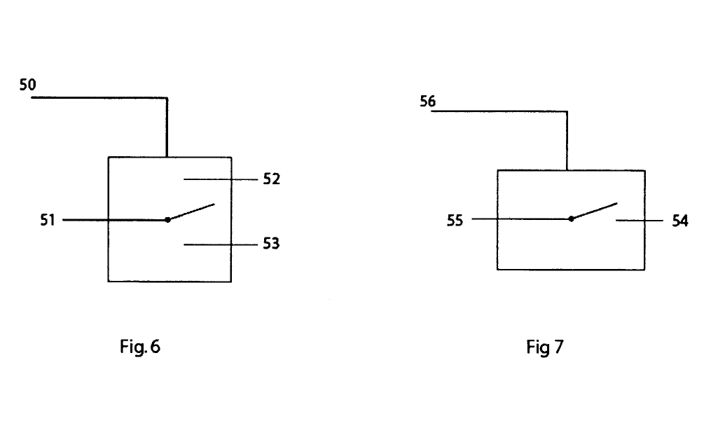

FIG. 6 shows a single-pole double-throw switch with a common contact 51, a normally closed contact 52, a normally open contact 53, and a control line 50. FIG. 7 shows a single-pole single-throw switch with a common contact 55, a normally open contact 54, and a control line 56.

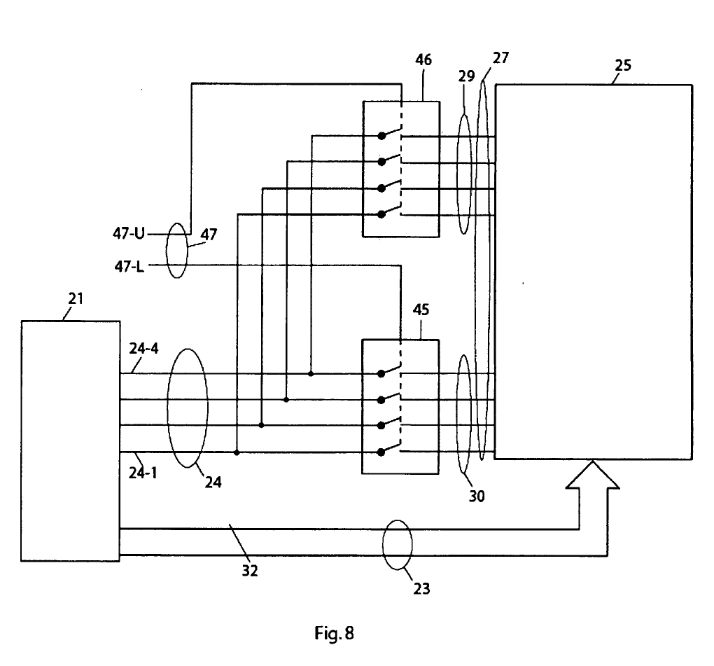

FIG. 8 shows a variant of the circuit of FIG. 3. In FIG. 8 what is shown are two multiplexers 45, 46 controlled by respective select lines 47-U and 47-L. It will be appreciated that the circuit of FIG. 8 differs from the circuit of FIG. 3 in that it is possible to activate both of the control lines 47-U and 47-L at the same time, if desired. This would permit, for example, a power-on self-test in which all segments are turned on. This circuit lacks the “cancel” circuit shown in FIG. 4.

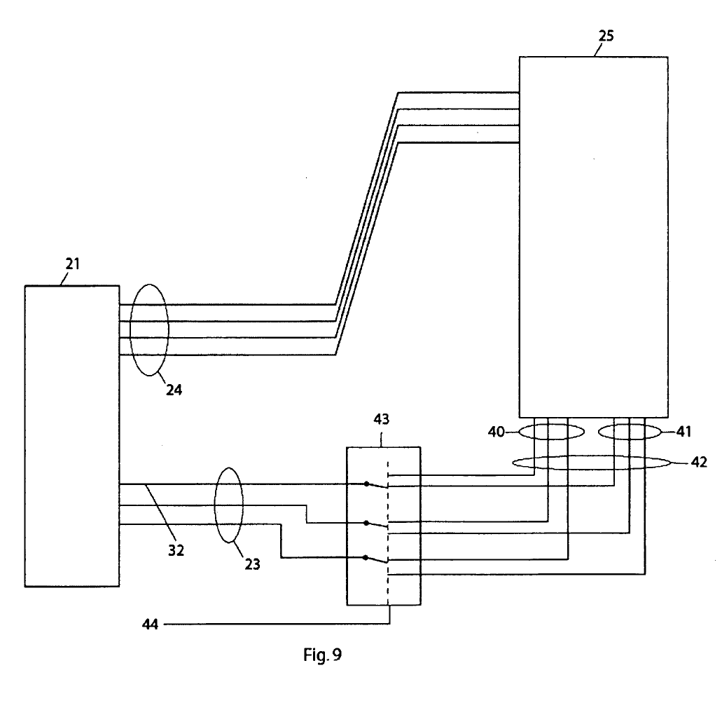

FIG. 9 shows multiplexing of segment lines rather than common lines. In this circuit, a multiplexer 43 is employed to permit segment drive lines 23 to control a larger number of segment leads 42. Selection line 44 is used to determine which subset of the segment drive leads 40, 41 is being activated at a particular time. This figure serves, among other things, to make clear that the terminology of “common” leads and “segment” leads is quite arbitrary. The names of the two types of leads are interchangeable for the purposes of the invention.

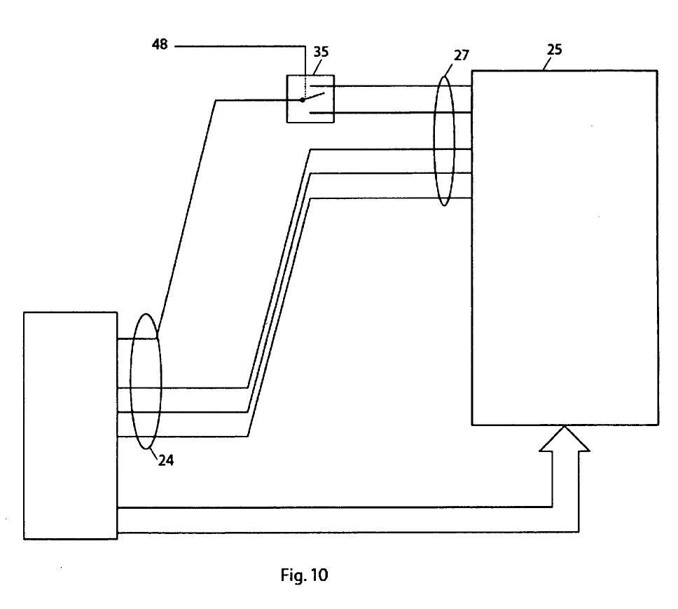

FIG. 10 shows multiplexing of less than all of the lines. In this case the multiplexed lines 24 are referred to as “common” lines but again as discussed above they could as well be referred to as “segment” lines. Regardless of whether the terminology is used in one way or in the complementary way, FIG. 10 shows how it may be decided to multiplex fewer than all of the lines 24 from the driver. In this case a switch 35 is used to multiplex only one of the lines 24 to a respective two leads 27.

FIG. 10 shows that one may multiplex individual segment lines or common lines. It is also to be noted that the number of display elements of the display 25 need not be an exact multiple of M times N. In a simplest case the visible circuitry of FIG. 10, the number of display elements controlled with the aid of a multiplexer could be as few as (M times N) plus 1. The circuitry of FIG. 10 could more generally permit controlling (M times N) plus N in the case where the switch 35 selects between either of two groups of N display elements (e.g. adding a row to an array). The circuitry of FIG. 10 could equally generally permit controlling (M times N) plus M in the case where the switch 35 selects between either of two groups of M display elements (e.g. adding a column to an array). It should again be borne in mind that the terminology of rows and columns is merely conceptual and that in actual applications the visible locations of particular display elements need not be in rows and columns. Finally in the most general case it is possible to multiplex both common lines and segment lines, in which case the number of display elements being controlled can be of the form (M times N) times P and Q where P is the expansion factor for one set of drive lines and where Q is the expansion factor for the other set of drive lines.

Those skilled in the art will have no difficulty whatsoever devising myriad obvious improvements and variations of the invention, all of which are intended to be encompassed within the claims which follow.

What is claimed is:

1. Apparatus comprising:
a liquid crystal display driver having N common drive lines and M segment drive lines, the liquid crystal display driver comprising an integrated circuit;
a liquid crystal display having M segment driver leads and N times P common drive leads, wherein P is at least two; and
P multiplexers, each external to the integrated circuit;
each of the M segment driver lines connected with a respective one of the M segment drive leads;
each multiplexer comprising N switches, each switch defining a normally-open contact, a normally-closed contact, and a common contact;
each of the switches connected by its common contact with a respective one of the common drive leads of the liquid crystal display;
each of the switches connected by its normally-closed contact with a cancel signal;
the N switches of each multiplexer each connected with a respective one of the N common drive lines of the liquid crystal display driver.

2. The apparatus of claim 1 wherein P is 2.

3. The apparatus of claim 2 wherein N is four and M is thirty-two.

4. The apparatus of claim 1 further comprising means driving each of the P multiplexers quickly in turn.

5. Apparatus comprising:
a liquid crystal display driver having N common drive lines and M segment drive lines, the liquid crystal display driver comprising an integrated circuit;
a liquid crystal display having M times R segment driver leads and N times P common drive leads, wherein P is at least two and R is at least two;
P common drive lead multiplexers, each external to the integrated circuit; and
R segment drive lead multiplexers, each external to the integrated circuit;
each segment drive lead multiplexers comprising M switches, each switch defining a normally-open contact, a normally-closed contact, and a common contact;
each of the switches of the segment drive lead multiplexer connected by its common contact with a respective one of the segment drive leads of the liquid crystal display;
each of the switches of the segment drive lead multiplexer connected by its normally-closed contact with a cancel signal;
the M switches of each segment driver lead multiplexer each connected with a respective one of the M segment drive leads of the liquid crystal display driver;
each common drive lead multiplexer comprising N switches, each switch defining a normally-open contact, a normally-closed contact, and a common contact;
each of the switches of the common lead multiplexer connected by its common contact with a respective one of the common drive leads of the liquid crystal display;
each of the switches of the common lead multiplexer connected by its normally-closed contact with a cancel signal;
the N switches of each common lead multiplexer each connected with a respective one of the N common drive lines of the liquid crystal display driver.

6. The apparatus of claim 5 wherein P is 2.

7. The apparatus of claim 6 wherein R is two.

8. The apparatus of claim 5 further comprising means driving each of the P multiplexers quickly in turn.

9. A method for use with a liquid crystal display and a display driver and a multiplexer external to the display driver, the display having common leads and segment leads, the display having segments each controlled by a respective common lead and a respective segment lead, the driver having common drive lines and segment drive lines, the method comprising the steps of:
employing the multiplexer to connect drive lines selectively to leads of the display.

10. The method of claim 9 wherein the connected drive lines are common drive lines and the connected leads are common leads.

11. The method of claim 9 wherein the connected drive lines are segment drive lines and the connected leads are segment leads.

12. The method of claim 9 wherein the selective connection of drive lines to leads is carried out quickly in turn.
